(19) United States
(12) Patent Application Publication
(10) Pub. No.: US 2005/0256214 A1
(43) Pub. Date: Nov. 17, 2005

(54) Poly (p-pheneylene 2-6 benzobisoxazole) foams

(76) Inventors: Robert P. Smart, Zeeland, MI (US); Dale C. Danver, Holland, MI (US)

Correspondence Address: BUTZEL LONG, 350 SOUTH MAIN STREET, SUITE 300, ANN ARBOR, MI, 48104, US

(21) Appl. No.: 11/127,561

(22) Filed: May 12, 2005

Related U.S. Application Data
(60) Provisional application No. 60/570,936, filed on May 13, 2004.

(51) Int. Cl. C08J 9/00

(52) U.S. Cl. 521/50

(57) ABSTRACT

Poly (p-pheneylene 2-6 benzobisoxazole) (PBO) compositions that can be used as resins, used as adhesives or adhesive components, used to form films and laminates and used to form foamed articles. The PBO compositions demonstrate high heat resistance, chemical stability, low flammability and low toxic fume generation. Foams can be produced from the PBO compositions that have a range of open and closed cellular structures. The PBO foams have specific densities of from at least about 0.25 lbs/ft³ to at least 50 lbs/ft³.

### RELATED APPLICATION

This application is related to U.S. Provisional Patent Application Ser. No. 60/570,936 entitled “Poly (P-pheneylene 2-6 benzobisoxazole) Foams”, filed May 13, 2004.

### TECHNICAL FIELD

The present invention relates generally to benzobisoxazoles. More specifically, the present invention relates to (p-pheneylene 2-6 benzobisoxazole) compositions that can be used as resins, adhesives or adhesive components, used to form films and laminates and used to form foamed articles.

### BACKGROUND ART

The synthesis and processing of thermally stable organic polymers has attracted much attention over the last quarter of a century. Of the wide variety of thermally stable systems produced, most are fully aromatic, rigid-rod polymers and therefore present great difficulties in processing due to their limited solubilities and high glass transitions. Current commercially available organic foams such as polystyrene, polyurethane, phenolic and polyimides are effective over a temperature range from cryogenic or about −260° C. to about 150° C. and up to about 330° C. for polyimide foams. A common method to overcome processing difficulties in these polymer systems is by synthesizing more flexible and soluble precursor polymers which, upon subsequent treatment, cyclize intramolecularly to produce thermally stable, rigid rod polymers. Polyimides, such as SOLREX® (Sordal Inc., Holland, Mich.), are familiar and successfully applied examples of this approach.

Low density porous materials, otherwise known as foams, were first developed in the United States in the mid 1930's. Despite the outstanding properties of common polymeric foams, such as excellent thermal and acoustic properties, high strength-to-weight ratios, and cost effectiveness, these materials suffer from certain disadvantages. Early polymeric foams have been limited in their use temperature, poor fire resistance (flammability and toxic fume generation), thermal aging and degradation, friability, and susceptibility to thermal cycling and UV light.

Based on a need for more fire resistance, less smoke generation, and higher operating temperatures, foams of polyimides, polyprones, polyphenylquinoxalines, and phenolic resins were developed. However, due to their high cost only the polyimide and phenolic foams have seen any commercial success. One of the earliest polyimide foam patents is credited to NASA Langley Research. NASA's patent describes a process whereby a novel polyimide foam was created from the reaction of a unique polyimide precursor residuum. These foams could be manufactured to densities ranging from 0.5 to 40 lbs/ft³ and had all the beneficial properties of other polyimide foams. However these foams did not meet the requirements of having a closed cell content greater than 75%.

Sordal, Inc. utilizing the polyimide precursor residuum in a modified form, developed an intermediate precursor termed “friable balloons.” The resultant friable balloons on the order of 200 micrometers could be placed in a contained space and foamed to a density ranging from 1 to 8 lbs. per cubic foot. These new foams, trademarked as SOLREX® by Sordal Inc., have the benefit of having a highly closed cell structure that retains integrity over a temperature range of from about −260° C. to about 330° C.

The Polymers Branch of the US Air Force Materials Directorate Laboratories in Dayton, Ohio had been challenged since the 1970's to develop a novel plastic material with the same performance as metals while maintaining the ductility of non-metallic materials. The new material was to be an alternative to graphite fiber in the areas of low weight to strength ratio, stiffness, environmental resistance, and better elongation and radar transparency. (The reduction of radar and infrared signatures is of high interest to the Air Force in conjunction with stealth warplanes and related military applications within the Department of Defense.) After many years of basic research, it was found that rigid rod polymers had the desired physical and chemical parameters, and poly (p-pheneylene 2-6 benzobisoxazole) (PBO) was successfully synthesized.

Molecular composite materials like PBO show superior properties when compared to state of the art materials like KEVLAR®, fiberglass, aramids, and graphite composites. PBO is based on a heterocyclic system derived from a liquid crystalline state. The AS (as-spun) PBO fiber is processed by dry-jet wet spinning techniques and is then heat treated under tension by passing through a tube oven at a temperature of 600° C.±50° C. under an inert atmosphere (nitrogen or argon) with a residence time of 10 to 30 seconds, depending on the denier of the fiber and the relative temperature. (Note: one denier of fiber=one gram of 9,000 meters of filament.) This technology was sold to DOW Chemical in 1985, who in turn sold it to its current owner, TOYOBO Company, Ltd. Osaka, Japan in 1992. (MITSUI Ltd. acts as TOYOBO's exclusive PBO fiber import agent in the U.S.)

The basic chemical structure of PBO is shown in FIG. 1. Note, the pulp form (used to make PBO paper) is somewhat modified when using a chemical digestion technique which would include the use of poly-phosphoric acid and chemical binders which will “steep” PBO pulp (e.g. a forced circulation of PBO fiber at elevated temperatures).

A detailed description of PBO and its synthesis can be found in “Rigid Rod Polymers and Molecular Composites”, presented by Dr. Fred Arnold (WPAFB-Dayton) and Dr. Fred Arnold Jr. (University of Akron) in the journal “Advances in Polymer Science”, Vol. 117 1994 pages 257-296.

Fibers which are classified as “high performance” generally have good thermo-oxidative properties (flame and heat resistance) or have high tensile strength and modulus. PBO is unique in that it has both superior thermal and tensile properties so desired in many aerospace and electronic applications. The resonance stabilization afforded by the aromatic structure of PBO lends itself to an increase in bond strength which contributes directly to its heat resistance. This is the principal mechanism which makes polybenoxazoles, polyimides, and polybenzimidazoles heat resistant fibers.

FIG. 1 is a graphical comparison of the tensile strength of PBO compared to other high performance fibers.

FIG. 2 is a graphical comparison of the tensile modulus of PBO compared to other high performance fibers.

FIG. 3 is a table comparing technical data of PBO and several other high performance materials (courtesy of Wright Paterson AFB Materials Directorate, Dayton, Ohio).

FIGS. 1-3 clearly show the range of properties that composite materials can display. These properties can be summed up as high strength and stiffness combined with low densities. PBO fiber clearly has the highest tensile strength and tensile modulus when compared to other high performance fibers used in a wide range of industries. PBO consists of rigid rod chain molecules, which provides for its high performance. Note that the tensile strength of PBO fiber is nearly ten times that of steel and twice that of aramid fibers.

FIG. 4 is a plot of the melting or decomposition temperatures of various materials verse the limiting oxygen index (LOI).

As can be seen from FIG. 4, PBO fiber has much higher decomposition temperature than aramid fibers, and its Limiting Oxygen Index (LOI) is the highest among super polymers. The very high LOI number of PBO of 68 means that the relative atmosphere must contain 68% oxygen to allow continuous burning. Air contains about 19% oxygen.

FIG. 5A is a graphical comparison of the gas combustion of PBO to aramid fibers.

FIG. 5B is a table of gases generated from PBO and aramid fibers at a temperature of 750° C. (1,382° F.).

As seem from FIGS. 5A and 5B, the amount of toxic gases such as hydrogen cyanide (HCN), nitrous oxides (NOx), and sulfurous oxides (SOx) from PBO fiber is very small compared to p-aramid fibers. Decomposition gases at 500° C. were also measured. The amount of toxic gases from PBO fiber is almost negligible. All values in the table above are reported in milligrams of particulate per gram of sample. This “life safety” data is important in material selection for stand-alone structures as well as for vehicles like personnel carriers, ships, submarines, and spacecraft.

FIG. 6 is a graph of strength retention of PBO and aramid fibers over time at a temperature of 500° C. (932° F.).

FIG. 6 clearly shows that PBO's strength retention is outstanding at higher temperatures. By way of example, PBO HM fiber retains 100% of its strength when exposed to 500° C. (932° F.) for one minute, whereas the aramid fiber fails after thirty seconds. These combined effects become critical in the design of thermally stable structural composite materials. PBO fiber is clearly superior to aramid fibers in the wide range of technical data presented, and there is far more data available in the area of chemical resistance and other specific areas of applied use where PBO is also dominant.

The present invention provides a process for producing PBO compositions that can be used as resins, used as adhesives or adhesive components, used to form films and laminates and used to form foamed articles. In each case, the resultant materials will incorporate all the desirable properties and characteristics associated with PBO fibers, including high heat resistance, chemical stability, low flammability and low toxic fume generation

### DISCLOSURE OF THE INVENTION

According to various features, characteristics and embodiments of the present invention which will become apparent as the description thereof proceeds, the present invention provides compositions of poly (p-pheneylene 2-6 benzobisoxazole) that can be used as resins, adhesives or adhesive components, used to form films and laminates and used to form foams and foamed products.

The present invention provides poly (p-pheneylene 2-6 benzobisoxazole) (PBO) foams and a process for producing the PBO foams. The PBO foams are thermally stable from about −260° C. to at least about 600° C. and have a maximum continuous operating temperature of about 500° C. PBO foams can be formed to have a specific density of from at least about 0.25 lbs/ft³ to at least 50 lbs/ft³ and a limiting oxygen index (LOI) that is greater than about 50% and less than about 80%. The PBO foams are non-flammable in earth's atmosphere and essentially non-toxic upon exposure.

The PBO foams can have either an open or closed cell configuration (suitable for acoustical applications and a specific density of from at least about 0.25 lbs/ft³ to at least 50 lbs/ft³.

The PBO foams have a moisture regain of less than about 1.0% and can fabricated in the form of a neat foam, in the form of friable balloons or in the form of microspheres.

The PBO foams are chemically inert in acidic and alkaline environments, and chemically inert in organic solvents such as in hydrocarbon solvents, ether solvents and ester solvents.

The PBO monomers of the present invention can be used together with other monomers in monomer blends that can be processed to form products and articles of manufacture.

### BRIEF DESCRIPTION OF DRAWINGS

The present invention will be described with reference to the attached drawings which are given as non-limiting examples only, in which:

FIG. 1 is a graphical comparison of the tensile strength of PBO compared to other high performance fibers.

FIG. 2 is a graphical comparison of the tensile modulus of PBO compared to other high performance fibers.

FIG. 3 is a table comparing technical data of PBO and several other high performance.

FIG. 4 is a plot of the melting or decomposition temperatures of various materials verse the limiting oxygen index (LOI).

FIG. 5A is a graphical comparison of the gas combustion of PBO to aramid fibers.

FIG. 5B is a table of gases generated from PBO and aramid fibers at a temperature of 750° C. (1,382° F.).

FIG. 6 is a graph of strength retention of PBO and aramid fibers over time at a temperature of 500° C. (932° F.).

FIG. 7 depicts the basic chemical structure of poly (p-pheneylene 2-6 benzobisoxazole) (PBO).

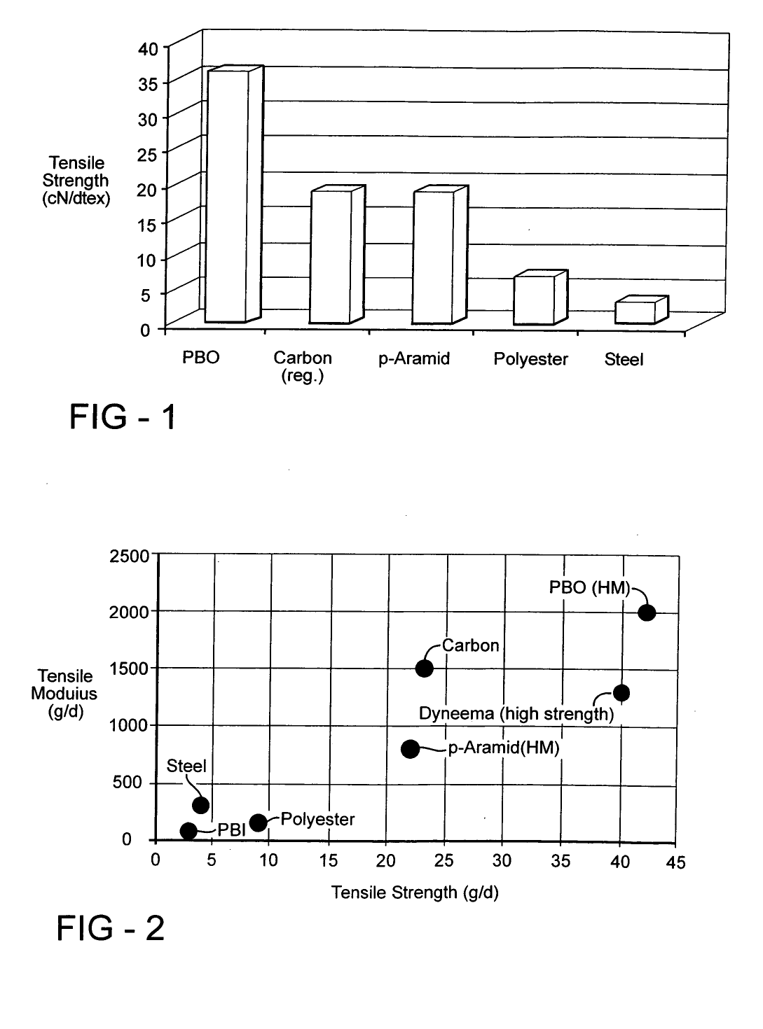

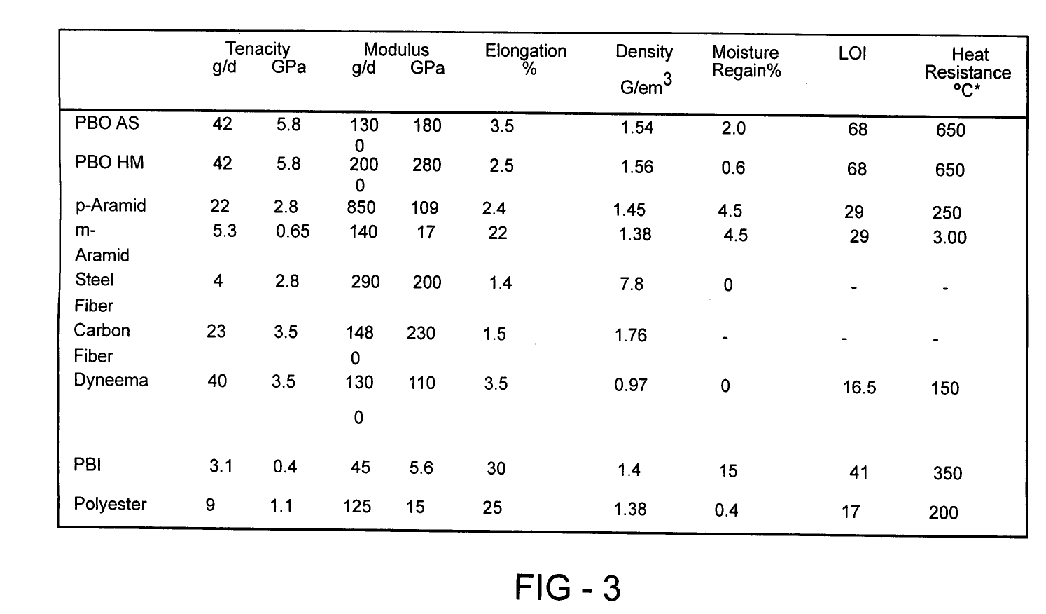

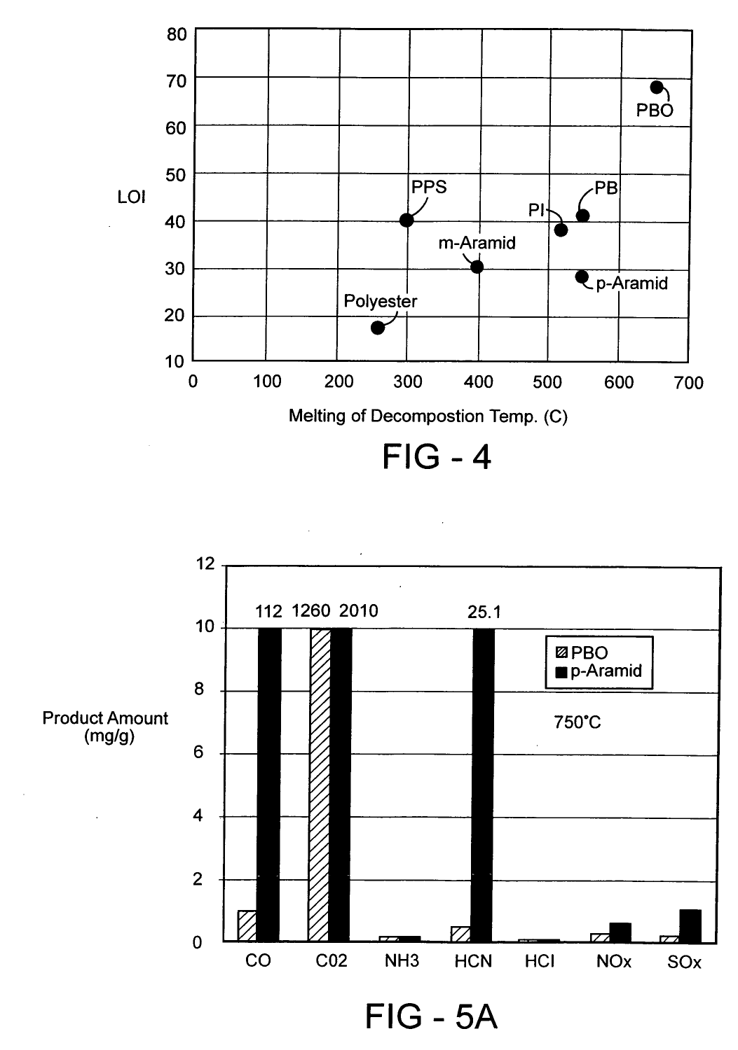

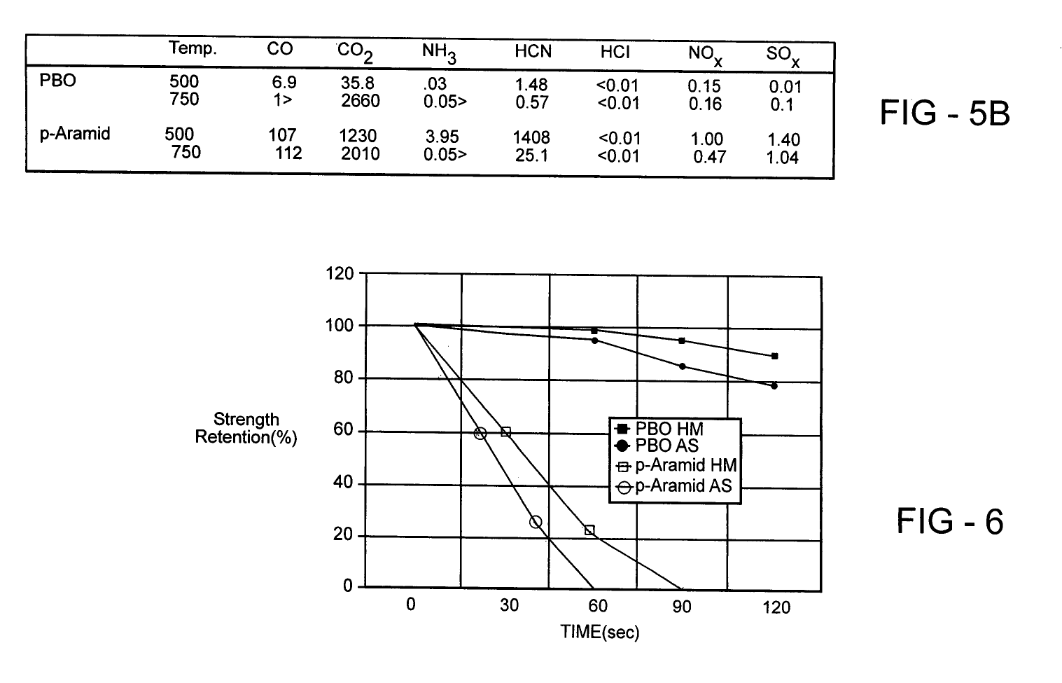

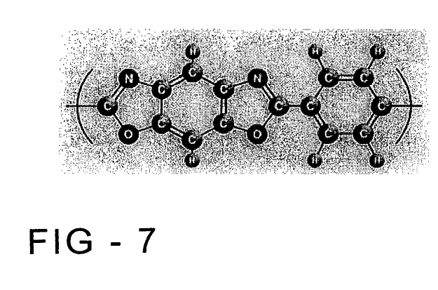

### BEST MODE FOR CARRYYING OUT THE INVENTION

The present invention is directed to (p-pheneylene 2-6 benzobisoxazole) (PBO) compositions that can be used as resins, adhesives or adhesive components, used to form films and laminates and used to form foamed articles.

The PBO compositions of the present invention can be presently employed in a number of applications, including, but not limited to joining metals to metals and joining metals to composite structures in the aerospace industry. In addition, the PBO foams of the present invention can be used as foam insulation materials in cryogenic applications and as structural foam that provide increased structural stiffness without large weight increases. The PBO foams of the present invention have exceptional thermal and mechanical properties which make them particularly suitable for use in future reusable launch vehicles, maritime ships, and aircraft. The PBO foams of the present invention have a number of beneficial attributes in these applications, such as high temperature and solvent resistance, flame resistance, low smoke generation, high modulus and chemical and hot water resistance.

The non-foamed PBO compositions, including PBO resins can be used in conventional resin applications, used to form films or laminates or used as adhesives or adhesives components. In each case the PBO compositions produced by the reaction process of the present invention will incorporate all the desirable properties and characteristics associated with PBO fibers, including high heat resistance, chemical stability, low flammability and low toxic fume generation

According to the present invention, the process for producing poly (p-pheneylene 2-6 benzobisoxazole) (PBO) foam is modeled after the process used to synthesize SOLREX®. The overall Chemical reaction mechanism for synthesizing SOLREX® closed cell polyimide foam is as follows:

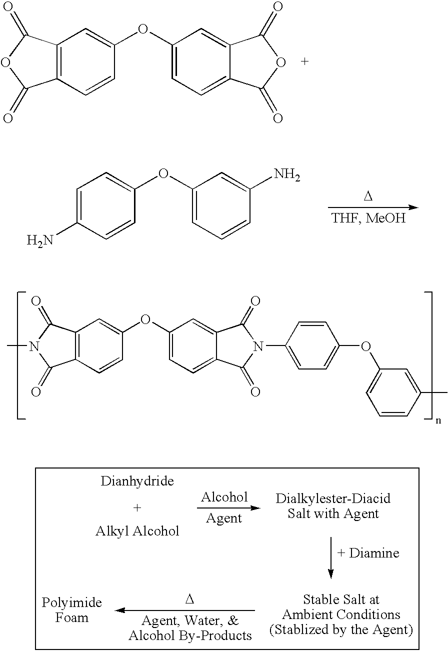

The synthesis of the SOLREX®, presented above, is trivial yet beautiful and will serve as a model process for the production of PBO foam. In the first step of the SOLREX® process, oxydiphthalic anhydride (ODPA), the dianhydride, reacts with the methanol-THF solvent mix to form the dimethylester-diacid of ODPA via an acyl substitution ring opening. At this stage of reaction, the diamine (3,4′-oxydianiline, ODA) in solution undergoes an acid base reaction with the carboxylic acid functionality to form a salt-like polyimide residuum. The creation of the friable balloon occurs when the solvent, THF, trapped in the crystal lattice of the homogeneous polyimide salt-like precursor, is converted into the gaseous form by a ramped heating process.

SOLREX® offers many exceptional properties for the nation's need for high performance polymer foams for both cryogenic and high-temperature insulation applications. Albeit, SOLREX® it is limited by its upper temperature range when compared to PBO Foam.

The present invention is based upon the design and development of a novel, low cost, robust, thermal insulating foam based on rigid poly (p-pheneylene 2-6 benzobisoxazole) which will begin to degrade at a temperature of 650° C. (1,202° F.) which is more than twice the decomposition temperature of polyimide foams. To synthesize PBO foam one must substitute the acyl chloride functionalities in terephthaloyl chloride (monomer of the traditional PBO synthesis) with dicyanomethylidene appendages. Upon vinylic nucleophilic substitution with bis(aminophenol), a stable, soluble o-hydroxy enaminonitrile will be produced. The increased solubility in common aprotic solvents of this PBO precursor makes it ideally suited to be converted into friable balloons via the Sordal polyimide technology.

The synthesis of PBO according to the present invention involves an in-situ polycondensation of bis(aminophenol) dihydrochloric salt and the aromatic diacid monomers in poly(phosphoric acid). The resulting rigid-rod polymer PBO is soluble only in acidic solvents such as polyphosphoric acid, methanesulfonic acid, fuming sulfuric acid, and Lewis acid salts. These harsh solvating conditions limit the processing capabilities of the PBO.⁵

Traditional Synthesis of PBO Resin Via A Soluble Precursor

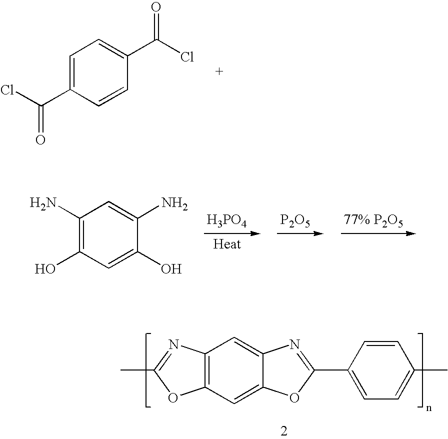

Synthesis of PBO Resin Via A Soluble Precursor According to the Present Invention

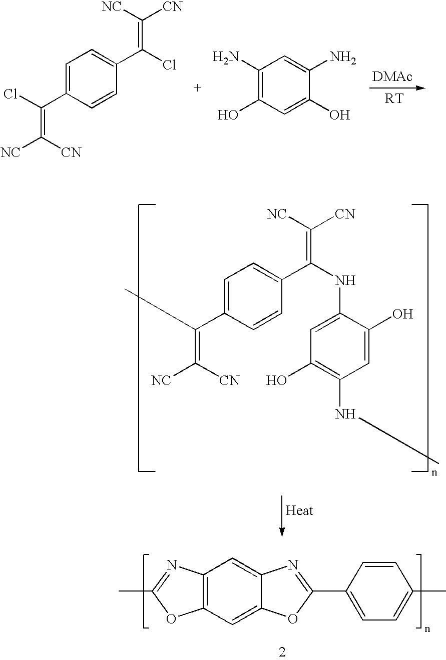

According to the present invention, processing difficulties in this polymer system will be overcome by substituting the acyl chloride functionalities in terephthaloyl chloride with dicyanomethylidene appendages as shown above. Upon vinylic nucleophilic substitution with bis(aminophenol), a stable o-hydroxy enaminonitrile will be produced. This precursor polymer will possess good solubility in typical polar aprotic solvents such as DMF, DMSO, and NMP, and also in acetone and THF. The good solubility in various organic solvents can be ascribed to the very polar structure of polymer backbone with cyanovinyl amine and hydroxy groups and their strong dipolar and hydrogen bonding interactions.

The substitution of the acyl chloride functionalities in terephthaloyl chloride with dicyanomethylidene appendages is based upon the close analogy between dicyanomethylidene, ═C(CN)₂, and the carbonyl oxygen of acid chlorides. The two units have similar inductive and resonance effects, and many well-known reactions with carbonyl groups have been shown to have close parallels with the dicyanovinyl groups. For example, (chlorodicyanovinyl)benzene, as an analog of the corresponding acid chloride, has been reacted with amines to form enaminonitrile linkage via a vinylic nucleophilic substitution reaction. In addition, the efficient synthesis of high molecular weight polymers using p-bis(1-chloro-2,2-dicyanovinyl)benzene with various diamines and diols is known.

During the course of the present invention it was determined that the dicyanovinyl analogs of benzoyl chloride and terephthaloyl chloride (1-chloro-2,2 dicyanovinyl) benzene and 1,4-bis(1,4-chloro-2,2-dicyanovinylbenzene) could be prepared respectively by substitution of acyl chloride functionalities with dicyanomethylidene appendages as discussed above and that model reactions of 2-aminophenol with (1-chlorlo-2,2 dicyanovinyl) benzene and 1,4-bis(lchloro-2,2-dicyanovinylbenzene) could be performed for purposes of monitoring the ring closure of the resulting o-hydroxy enaminonitriles, 4 and 7, to form the corresponding benzoxazoles, 5 and 8 using TGA, DSC, and react IR as illustrated below:

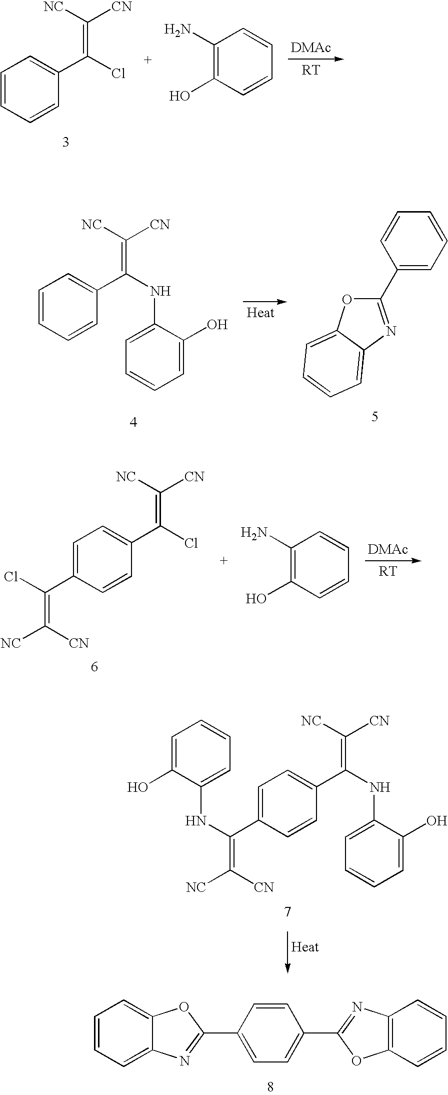

The particle size distribution of the PBO friable balloons and its resulting density and closed cell content of the PBO foam can be optimized as desired. The relationship between closed cell PBO foam and Open Cell PBO foam is directed related to the diameter of the PBO friable balloon and the wall thickness of the PBO friable balloons.

The formation of PBO foams and foamed products is only one manner in which the resulting PBO can be utilized. Other uses include the use of the PBO as a resin, in the formation of films and laminates and the use of the PBO as an adhesive or an ingredient in adhesive compositions.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A PBO foam that is thermally stable from about −260° C. to at least about 600° C.

2. A PBO foam according to claim 1, having a maximum continuous operating temperature of about 500° C.

3. A PBO foam according to claim 1, having a specific density of from at least about 0.25 lbs/ft³ to at least 50 lbs/ft³.

4. A PBO foam according to claim 1, having a limiting oxygen index (LOI) that is greater than about 50% and less than about 80%.

5. A PBO foam according to claim 4, having a limiting oxygen index (LOI) of about 68%.

6. A PBO foam according to claim 1, which is non-flammable in earth's atmosphere.

7. A PBO foam according to claim 1, which is essentially non-toxic upon exposure.

8. A PBO foam according to claim 1, which is produced from a poly (p-pheneylene 2-6 benzobisoxazole) organic resin.

9. A PBO foam according to claim 1, which has an open cell configuration for acoustical applications and a specific density of from at least about 0.25 lbs/ft³ to at least 50 lbs/ft³.

10. A PBO foam according to claim 1, which has a closed cell configuration for acoustical applications and a specific density of from at least about 0.25 lbs/ft³ to at least 50 lbs/ft³.

11. A PBO foam according to claim 1, which has a moisture regain of less than about 1.0%

12. A PBO foam according to claim 1, which is fabricated in the form of a neat foam.

13. A PBO foam according to claim 1, which is fabricated in the form of friable balloons.

14. A PBO foam according to claim 1, which is fabricated in the form of microspheres.

15. A PBO foam according to claim 1, which is chemically inert in acidic and alkaline environments.

16. A PBO foam according to claim 1, which is chemically inert in organic solvents.

17. A PBO foam according to claim 16, which is inert in hydrocarbon, ether and ester solvents.

18. A blend of monomers which includes a PBO monomer.

19. A cured product made from the monomer blend of claim 18.
